(19) United States
(12) Patent Application Publication
(10) Pub. No.: US 2021/0321030 A1
(43) Pub. Date: Oct. 14, 2021

(54) BANDWIDTH AND POWER REDUCTION FOR STAGGERED HIGH DYNAMIC RANGE IMAGING TECHNOLOGIES

(71) Applicant: QUALCOMM Incorporated, San Diego, CA (US)

(72) Inventors: Rohan DESAI, San Diego, CA (US); Scott CHENG, Foothill Ranch, CA (US); Edoardo REGINI, San Diego, CA (US)

(21) Appl. No.: 16/844,515

(22) Filed: Apr. 9, 2020

(51) Int. Cl. H04N 5/235; H04N 5/232

(52) U.S. Cl. CPC H04N 5/2355; H04N 5/2353; H04N 5/23222

(57) ABSTRACT

Systems, methods, and non-transitory media are provided for reducing resource and power usage and requirements in staggered high dynamic range (HDR) applications. For example, a first exposure including a set of image data associated with a frame can be stored in memory. The first exposure has a first exposure time and is captured by an image sensor during a first time period associated with the frame. The first exposure can be obtained from the memory, and a second exposure including a set of image data associated with the frame can be obtained from a cache or the image sensor. The second exposure has a second exposure time and is captured by the image sensor during a second time period associated with the frame. The sets of image data from the first and second exposures can be merged, and an HDR image generated based on the sets of image data merged.

### TECHNICAL FIELD

The present disclosure generally relates to high dynamic range imaging, and more specifically to bandwidth and power reduction for staggered high dynamic range imaging.

### BACKGROUND

Image sensors are commonly integrated into a wide array of electronic devices such as cameras, mobile phones, autonomous systems (e.g., autonomous drones, cars, robots, etc.), computers, smart wearables, and many other devices. The image sensors allow users to capture video and images from any electronic device equipped with an image sensor. The video and images can be captured for recreational use, professional photography, surveillance, and automation, among other applications. The quality of a video or image can depend on the capabilities of the image sensor used to capture the video or image and a variety of factors such as exposure. Exposure relates to the amount of light that reaches the image sensor, as determined by shutter speed or exposure time, lens aperture, and scene luminance.

High dynamic range (HDR) imaging technologies are often used when capturing images of a scene with bright and dark areas to produce higher quality images. The HDR imaging technologies can combine different exposures to reproduce a greater range of color and luminance levels than otherwise possible with standard imaging techniques. The HDR imaging technologies can help retain or produce a greater range of highlight, color, and shadow details on a captured image. Consequently, HDR imaging technologies can yield better quality images in scenes with a wide array of lighting conditions. However, HDR imaging technologies generally involve additional computational processing, which can increase power and resource usage at the device and raise the thermal load on the device. Such power, resource and thermal demands are often exacerbated by trends towards implementing image sensors and HDR imaging technologies in mobile and wearable devices, and making such devices smaller, lighter and more comfortable to wear (e.g., by reducing the heat generated by the device).

### BRIEF SUMMARY

Disclosed are systems, methods, and computer-readable media for reducing bandwidth and power usage and requirements in staggered high dynamic range (HDR) applications. According to at least one example, a method is provided for reducing resource and power usage and requirements in staggered HDR applications. The method can include storing, in a first memory, a first exposure including a first set of image data associated with a frame, the first exposure having a first exposure time and being captured by an image sensor during a first time period associated with the frame; obtaining the first exposure from the first memory; obtaining, from one of a second memory or the image sensor, a second exposure including a second set of image data associated with the frame, the second exposure having a second exposure time that is different than the first exposure time, the second exposure being captured by the image sensor during a second time period associated with the frame; merging the first set of image data from the first exposure and the second set of image data from the second exposure; and generating a high dynamic range (HDR) image based on the first set of image data and the second set of image data merged from the first exposure and the second exposure.

According to at least one example, a non-transitory computer-readable medium is provided for reducing resource and power usage and requirements in staggered HDR applications. The non-transitory computer-readable medium can include computer-readable instructions which, when executed by one or more processors, cause the one or more processors to store, in a first memory, a first exposure including a first set of image data associated with a frame, the first exposure having a first exposure time and being captured by an image sensor during a first time period associated with the frame; obtain the first exposure from the first memory; obtain, from one of a second memory or the image sensor, a second exposure including a second set of image data associated with the frame, the second exposure having a second exposure time that is different than the first exposure time, the second exposure being captured by the image sensor during a second time period associated with the frame; merge the first set of image data from the first exposure and the second set of image data from the second exposure; and generate a high dynamic range (HDR) image based on the first set of image data and the second set of image data merged from the first exposure and the second exposure.

According to at least one example, an apparatus is provided for reducing resource and power usage and requirements in staggered HDR applications. The apparatus can include at least one memory and one or more processors implemented in circuitry and configured to store, in a first memory, a first exposure including a first set of image data associated with a frame, the first exposure having a first exposure time and being captured by an image sensor during a first time period associated with the frame; obtain the first exposure from the first memory; obtain, from one of a second memory or the image sensor, a second exposure including a second set of image data associated with the frame, the second exposure having a second exposure time that is different than the first exposure time, the second exposure being captured by the image sensor during a second time period associated with the frame; merge the first set of image data from the first exposure and the second set of image data from the second exposure; and generate a high dynamic range (HDR) image based on the first set of image data and the second set of image data merged from the first exposure and the second exposure.

According to at least one example, an apparatus can include means for storing, in a first memory, a first exposure including a first set of image data associated with a frame, the first exposure having a first exposure time and being captured by an image sensor during a first time period associated with the frame; obtaining the first exposure from the first memory; obtaining, from one of a second memory or the image sensor, a second exposure including a second set of image data associated with the frame, the second exposure having a second exposure time that is different than the first exposure time, the second exposure being captured by the image sensor during a second time period associated with the frame; merging the first set of image data from the first exposure and the second set of image data from the second exposure; and generating a high dynamic range (HDR) image based on the first set of image data and the second set of image data merged from the first exposure and the second exposure.

In some aspects, the method, non-transitory computer-readable medium, and apparatuses described above can include obtaining the first set of image data and the second set of image data from the image sensor, the frame including the first set of image data and the second set of image data, wherein the first exposure includes a first portion of the frame and the second exposure includes a second portion of the frame, and wherein the first exposure and the second exposure are captured within a frame rate of the frame.

In some examples, the second memory can include a cache. Moreover, in some examples, the first memory can include a volatile memory and the volatile memory can include one of a random access memory (RAM), a dynamic RAM (DRAM), a static RAM (SRAM), a synchronous DRAM (SDRAM), or a double data rate (DDR) SDRAM. In some aspects, the first exposure can be obtained from the volatile memory based on a higher priority parameter associated with a lower latency.

In some aspects, the method, non-transitory computer-readable medium, and apparatuses described above can include obtaining a third exposure including a third set of image data associated with the frame, the third exposure being received from the image sensor without first storing the third exposure in the first memory or the second memory; merging the first set of image data from the first exposure, the second set of image data from the second exposure, and the third set of image data from the third exposure; and generating the HDR image based on the first set of image data, the second set of image data, and the third set of image data merged from the first exposure, the second exposure, and the third exposure.

In some examples, the first set of image data, the second set of image data, and the third set of image data from the first exposure, the second exposure, and the third exposure are merged using one or more processors and the HDR image is generated using one or more processors, wherein the first exposure is obtained by the one or more processors from the first memory, the second exposure is obtained by the one or more processors from the second memory, and the third exposure is obtained by the one or more processors from the image sensor.

In some cases, the first set of image data of the first exposure can include a first portion of the frame, the second set of image data of the second exposure can include a second portion of the frame, and the third set of image data of the third exposure can include a third portion of the frame, wherein the first exposure, the second exposure, and the third exposure are captured within a frame rate associated with the frame, the third exposure having a third exposure time and being captured by the image sensor during a third time period associated with the frame. In some examples, the first exposure time is less than the second exposure time, and the second exposure time is less than the third exposure time.

In some cases, obtaining the second exposure from one of the second memory or the image sensor can include obtaining the second exposure from the image sensor without first storing the second exposure in the first memory or the second memory.

In some aspects, the method, non-transitory computer-readable medium, and apparatuses described above can include initiating the merging of the first set of image data from the first exposure and the second set of image data from the second exposure as the first exposure is obtained from the first memory and the second exposure is obtained from the image sensor; and merging the first set of image data from the first exposure and the second set of image data from the second exposure after the first exposure is obtained from the first memory and the second exposure is obtained from the image sensor.

In some examples, the first exposure time can be less than the second exposure time. In other examples, the first exposure time can be greater than the second exposure time.

In some examples, the first exposure and the second exposure are received by an image processing system (e.g., the apparatus) and/or one or more processors associated with the first memory and the second memory, wherein the first exposure is received by the image processing system and/or the one or more processors before the second exposure, and wherein the first exposure time associated with the first exposure and the second exposure time associated with the second exposure are within a frame rate associated with the frame. In other examples, the first exposure and the second exposure are received by an image processing system (e.g., the apparatus) and/or one or more processors associated with the first memory and the second memory, wherein the first exposure is received by the image processing system and/or the one or more processors after the second exposure, and wherein the first exposure time associated with the first exposure and the second exposure time associated with the second exposure are within a frame time associated with the frame.

In some aspects, the apparatuses described above can include one or more sensors. In some examples, the apparatuses described above can include or can be a mobile phone, a wearable device, a display device, a mobile computer, a head-mounted device, and/or a camera.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

In order to describe the manner in which the above-recited and other advantages and features of the disclosure can be obtained, a more particular description of the principles described above will be rendered by reference to specific embodiments thereof which are illustrated in the appended drawings. Understanding that these drawings depict only example embodiments of the disclosure and are not to be considered to limit its scope, the principles herein are described and explained with additional specificity and detail through the use of the drawings in which:

FIG. 1 is a simplified block diagram illustrating an example image processing system for staggered high dynamic range imaging, in accordance with some examples of the present disclosure.

FIG. 2 is a simplified block diagram illustrating an example staggered high dynamic range image capture sequence, in accordance with some examples of the present disclosure.

FIG. 3 through FIG. 5 are simplified block diagrams illustrating example implementations of a staggered high dynamic range process, in accordance with some examples of the present disclosure.

FIG. 6 illustrates an example high dynamic range image generated according to an example staggered high dynamic range process by merging a longer exposure captured by an image sensor and a shorter exposure captured by the image sensor, in accordance with some examples of the present disclosure.

FIG. 7 illustrates an example for implementing a staggered high dynamic range process and reducing the resource and power usage and requirements of the staggered high dynamic range process, in accordance with some examples of the present disclosure.

FIG. 8 illustrates an example computing device architecture, in accordance with some examples of the present disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

As previously noted, image sensors are commonly integrated into a wide array of electronic devices such as cameras, mobile phones, autonomous systems (e.g., autonomous drones, cars, robots, etc.), computers, Internet-of-Things (IoT) devices, smart wearables, and many other devices. As a result, video and image recording capabilities have become ubiquitous as increasingly more electronic devices are equipped with such image sensors. In addition, high dynamic range (HDR) imaging technologies are frequently implemented by such electronic devices to produce higher quality images when capturing images of a scene with bright and dark areas. Unfortunately, because HDR imaging technologies generally involve additional computational processing, they can significantly increase power and resource (e.g., bandwidth, compute, storage, etc.) usage at the device and raise the thermal load on the device.

In some examples, the disclosed technologies address these and other challenges by providing techniques to reduce the power and resource usage and requirements and thermal load on devices when implementing staggered HDR. Staggered HDR (or line-based HDR) can be used to merge two or more exposures captured for a frame of a scene to generate an HDR image. The two or more exposures can have different exposure times, which when merged to generate the HDR image allow the HDR image to retain and/or produce a greater range of color and luminance levels and details (e.g., highlight details, shadow details, etc.). For example, staggered HDR (sHDR) can be used to merge long, medium, and/or short exposures captured for a frame, which can then be merged to produce an HDR image that captures a wider array of color and luminance levels. The exposures can be staggered in time, written to memory, and subsequently retrieved from memory to merge the exposures in a synchronized fashion.

This sHDR process can have high bandwidth and power costs, which are exacerbated by having to write each exposure to memory and read all exposures back from memory at the time of merging. However, the disclosed technologies can reduce such bandwidth and power costs, among other costs and burdens such as compute costs and thermal load. In some examples, the disclosed technologies can initiate the exposure merge process when the last exposure (of a group of exposures used for sHDR) starts and can avoid writing and reading that last exposure to and from a power hungry and compute intensive memory, such as a double data rate (DDR) synchronous dynamic random-access memory (SDRAM), and thereby reduce the costs associated with writing and reading the last exposure to and from such memory.

For example, instead of saving the last exposure to a power hungry and compute intensive memory, the last exposure can be cached in a buffer or other memory that is less power hungry and compute intensive, such as a level 2 cache (L2 cache), and retrieved from the buffer or other memory when merging with the other exposures. In some cases, if the buffer is sufficiently large to support some or all of the other exposures, the sHDR process disclosed herein can similarly save such exposures to the buffer and retrieve them from the buffer during the merge process. This can provide additional power and bandwidth savings by avoiding additional write and read operations to the more power hungry and compute intensive system memory.

In some cases, the last exposure can bypass the memory and instead be processed inline (e.g., in real time or near real time) and thereby merged with the other exposures without performing separate write and read operations for that last exposure. For example, the last exposure can be obtained directly from the image sensor after being captured and merged with the other exposures obtained offline from memory. In some examples, because traffic from the image sensor (e.g., the last exposure) is combined with offline traffic obtained (e.g., read) from memory, a quality-of-service (QOS) mechanism can be implemented to ensure that the reads from memory do not fall behind in time (e.g., out of synchrony). This can be performed by allocating a latency buffer for the reads from memory and using a buffer-based QoS mechanism to ensure the reads arrive in time (e.g., relative to the last exposure processed inline or in real time). When the buffer is empty, the QoS priority can be high. The QoS priority can be lowered as the buffer starts to fill up.

In some cases, the sHDR process disclosed herein can implement a hybrid mechanism where the last exposure bypasses any memory and is instead processed inline (e.g., in real time or near real time) as described above, but one or more of the other exposures are saved to a buffer instead of being saved and retrieved to and from a power hungry and compute intensive system memory. Thus, this approach can save bandwidth and power costs by not only avoiding write and read operations for the last exposure, which is obtained and processed directly from the image sensor, but also avoiding having to write and read one or more other exposures to and from a system memory, and instead caching such exposures in a buffer and retrieving them from the buffer when merging the exposures to produce the HDR image.

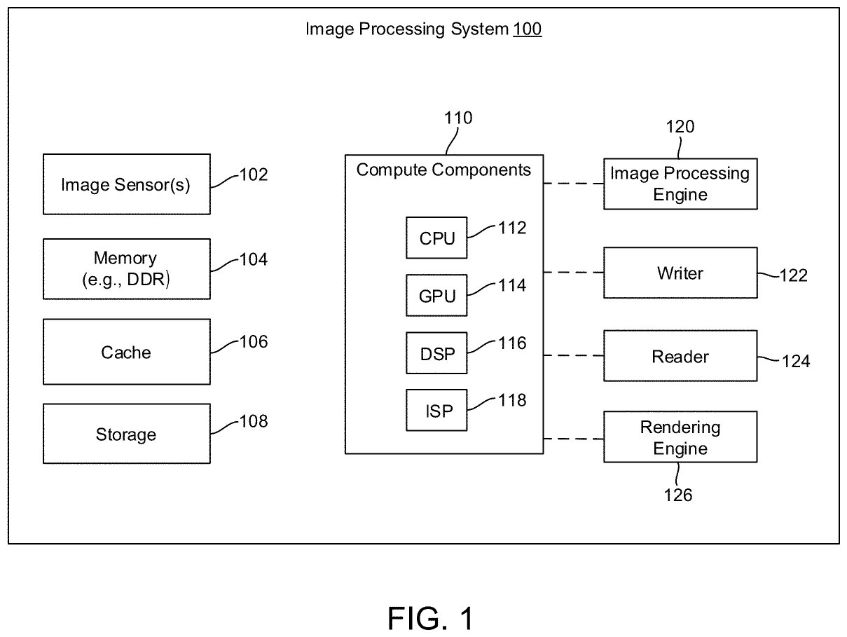

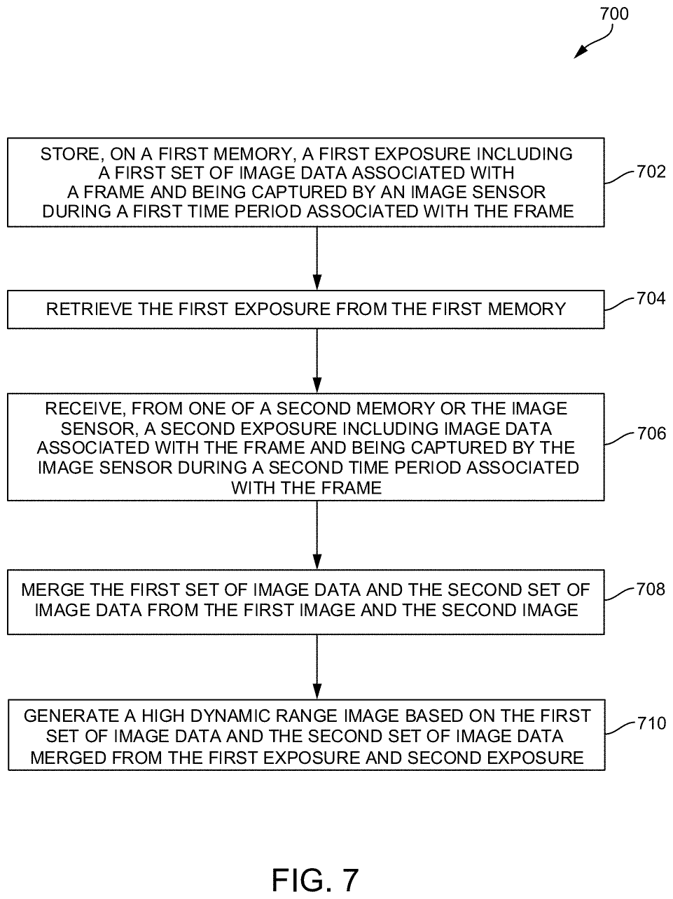

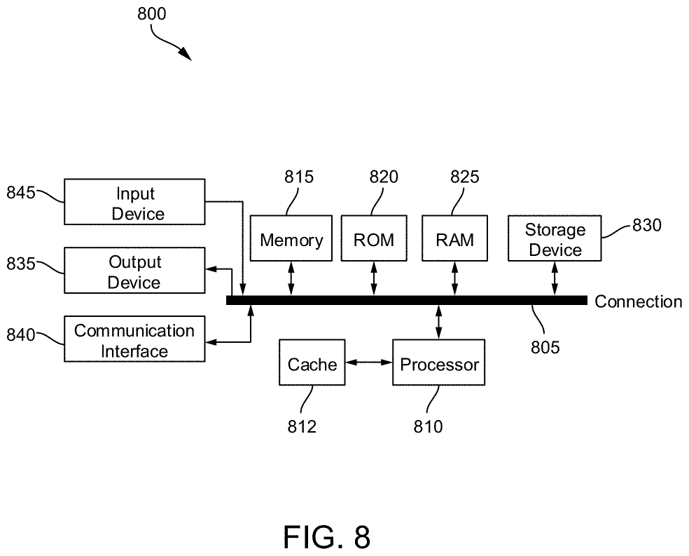

The present technology will be described in greater detail in the following disclosure. The discussion begins with a description of example systems, techniques and applications for reducing resource and power usage and requirements in staggered high dynamic range applications, as illustrated in FIG. 1 through FIG. 6. A description of an example method for reducing resource and power usage and requirements in staggered high dynamic range applications, as illustrated in FIG. 7, will then follow. The discussion concludes with a description of an example computing device architecture including example hardware components suitable for reducing resource and power usage and requirements in staggered high dynamic range applications, as illustrated in FIG. 8. The disclosure now turns to FIG. 1.

FIG. 1 is a diagram illustrating an example image processing system 100 for reducing resource and power usage and requirements in staggered high dynamic range (sHDR) applications. In this illustrative example, the image processing system 100 includes one or more image sensors 102, a memory 104, a cache 106, storage 108, compute components 110, an image processing engine 120, a writer 122, a reader 124, and a rendering engine 126.

The image processing system 100 can be part of a computing device or multiple computing devices. In some examples, the image processing system 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a laptop or notebook computer, a tablet computer, a set-top box, a television, a display device, a digital media player, a gaming console, a video streaming device, a drone, a computer in a car, an IoT (Internet-of-Things) device, a smart wearable device, an extended reality device (e.g., an augmented, virtual, and/or mixed reality device, such as a head-mounted display (HMD)), or any other suitable electronic device(s). In some implementations, the image sensor(s) 102, the memory 104, the cache 106, the storage 108, the compute components 110, the image processing engine 120, the writer 122, the reader 124, and the rendering engine 126 can be part of the same computing device. For example, in some cases, the image sensor(s) 102, the memory 104, the cache 106, the storage 108, the compute components 110, the image processing engine 120, the writer 122, the reader 124, and the rendering engine 126 can be integrated into a camera, smartphone, laptop, tablet computer, smart wearable device, gaming system, an HMD or other extended reality device, and/or any other computing device. However, in some implementations, the image sensor(s) 102, the memory 104, the cache 106, the storage 108, the compute components 110, the image processing engine 120, the writer 122, the reader 124, and the rendering engine 126 can be part of two or more separate computing devices.

The image sensor(s) 102 can include any image and/or video sensor or capturing device, such as a digital camera sensor, a video camera sensor, a smartphone camera sensor, an image/video capture device on an electronic apparatus such as a television or computer, a camera, etc. In some cases, the image sensor(s) 102 can be part of a camera or computing device such as a digital camera, a video camera, an IP camera, a smartphone, a smart television, a game system, etc. In some examples, the image sensor(s) 102 can include multiple image sensors, such as rear and front sensor devices, and can be part of a dual-camera or other multi-camera assembly (e.g., including two camera, three cameras, four cameras, or other number of cameras). The image sensor(s) 102 can capture image and/or video frames (e.g., raw image and/or video data), which can then be processed by the compute components 110, the image processing engine 120, the writer 122, the reader 124, and/or the rendering engine 126, as further described herein.

The memory 104 can include one or more memory devices, and can include any type of memory such as, for example, volatile memory (e.g., RAM, DRAM, SDRAM, DDR, static RAM, etc.), flash memory, flashed-based memory (e.g., solid-state drive), etc. In some examples, the memory 104 can include one or more DDR (e.g., DDR, DDR2, DDR3, DDR4, etc.) memory modules. In other examples, the memory 104 can include other types of memory module(s). The memory 104 can be used to store data such as, for example, frames or exposures captured by the image sensor 102 and subsequently processed by the image processing system 100, processing parameters, metadata, and/or any type of data. In some cases, the memory 104 can have faster data transfer rates (e.g., for read and/or write operations) than storage 108 and can thus be used to store data with higher latency and/or performance requirements than supported by storage 108. In some examples, the memory 104 can be used to store data from and/or used by the image sensor 102, the compute components 110, the image processing engine 120, the writer 122, the reader 124, and/or the rendering engine 126.

The cache 106 can include one or more hardware and/or software components that store data so that future requests for that data can be served faster than if stored on the memory 104 or storage 108. For example, the cache 106 can include any type of cache or buffer such as, for example, system cache or L2 cache. The cache 106 can be faster and/or more cost effective than the memory 104 and storage 108. Moreover, the cache 106 can have a lower power and/or operational demand or footprint than the memory 104 and storage 108. Thus, in some cases, the cache 106 can be used to store/buffer and quickly serve certain types of data expected to be processed and/or requested in the future by one or more components (e.g., compute components 110) of the image processing system 100, such as frames/exposures captured by the image sensor 102, as further described herein. In some examples, the cache 106 can be used to cache or buffer data from and/or used by the image sensor 102, the compute components 110, the image processing engine 120, the writer 122, the reader 124, and/or the rendering engine 126. While a cache is used as an example of a faster and/or more cost effective memory mechanism that the memory 104 and the storage 108, any other suitable low power memory mechanism can be used in implementing the technologies described herein.

The storage 108 can be any storage device(s) for storing data. Moreover, the storage 108 can store data from any of the components of the image processing system 100. For example, the storage 108 can store data from the image sensor(s) 102 (e.g., frames, videos, exposures, etc.), data from and/or used by the compute components 110 (e.g., processing parameters, sHDR images, processing outputs, software, files, settings, etc.), data from and/or used by the image processing engine 120 (e.g., sHDR data and/or parameters, image processing data and/or parameters, etc.), data stored by the writer 122, data accessed by the reader 124, data from and/or used by the rendering engine 126 (e.g., output frames), an operating system of the image processing system 100, software of the image processing system 100, and/or any other type of data. In some examples, the storage 108 can include a buffer for storing frames or exposures for processing by the compute components 110. In some cases, the storage 108 can include a display buffer for storing frames previewing and a video buffer for storing frames or exposures for encoding/recording, as further described herein.

The compute components 110 can include a central processing unit (CPU) 112, a graphics processing unit (GPU) 114, a digital signal processor (DSP) 116, and an image signal processor (ISP) 118. The compute components 110 can perform various operations such as HDR (including sHDR and/or any other type of HDR), image enhancement, computer vision, graphics rendering, augmented reality, image/video processing, sensor processing, recognition (e.g., text recognition, object recognition, feature recognition, tracking or pattern recognition, scene change recognition, etc.), electronic image stabilization (EIS), machine learning, filtering, illumination, and any of the various operations described herein. In the example shown in FIG. 1, the compute components 110 implement an image processing engine 120, a writer 122, a reader 124, and a rendering engine 126. In other examples, the compute components 110 can also implement one or more image processing engines and/or any other processing engines.

The operations for the image processing engine 120, the writer 122, the reader 124, and the rendering engine 126 (and any other processing engines) can be implemented by any of the compute components 110. In one illustrative example, the operations of the rendering engine 126 can be implemented by the GPU 114, and the operations of the image processing engine 120, the writer 122, the reader 124, and/or one or more other processing engines can be implemented by the CPU 112, the DSP 116, and/or the ISP 118. In some examples, the operations of the image processing engine 120, the writer 122 and the reader 124 can be implemented by the ISP 118. In other examples, the operations of the image processing engine 120, the writer 122, and the reader 124 can be implemented by the ISP 118, the CPU 112, the DSP 116, and/or a combination of the ISP 118, the CPU 112, and the DSP 116.

In some cases, the compute components 110 can include other electronic circuits or hardware, computer software, firmware, or any combination thereof, to perform any of the various operations described herein. In some examples, the ISP 118 can receive data (e.g., image data such as frames or exposures with different exposure times) captured by the image sensor 102 and process the data to generate output frames intended for output to a display. For example, the ISP 118 can receive exposures captured by image sensor 102 with different exposure times, perform sHDR on the captured exposures, and generate an output HDR image for storage, sharing, and/or display. In some examples, an exposure can include image data associated with a frame, such as lines of pixels, rows of pixels, and/or different pixels and/or color channels of a frame. In some cases, different exposures can have different exposure times and can be merged to generate a frame associated with the different exposures, as further described herein. For example, in some cases, different exposures can include different lines of pixels of a frame captured within a frame rate of the frame, with each exposure having a different exposure time. In some examples, the different exposures can be captured sequentially, with or without some overlap in time.

A frame can include a video frame of a video sequence or a still image. A frame can include a pixel array representing a scene. For example, a frame can be a red-green-blue (RGB) frame having red, green, and blue color components per pixel; a luma, chroma-red, chroma-blue (YCbCr) frame having a luma component and two chroma (color) components (chroma-red and chroma-blue) per pixel; or any other suitable type of color or monochrome picture. In some examples, an sHDR image or frame can include multiple exposures merged together as further described herein. For example, a frame of an sHDR image can include different exposures that have different exposure times and that are merged together to generate the frame.

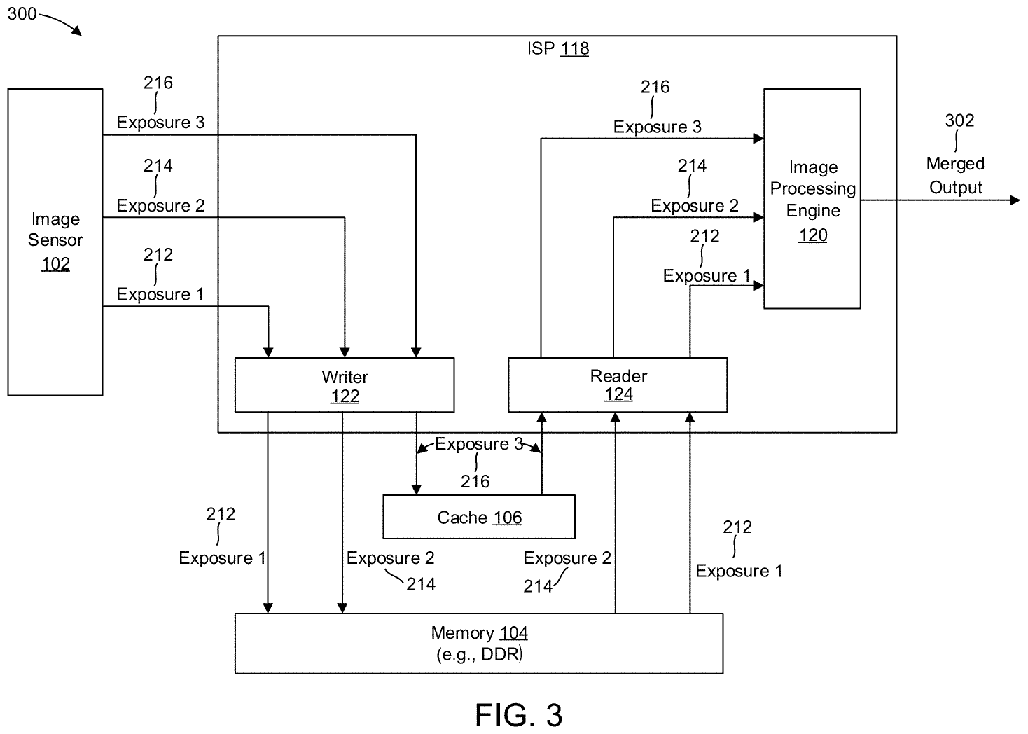

The ISP 118 can implement one or more image processing engines and can perform image processing operations, such as HDR (including sHDR and/or any other type of HDR), filtering, demosaicing, scaling, color correction, color conversion, noise reduction filtering, spatial filtering, EIS, etc. The ISP 118 can process frames captured by the image sensor 102; frames in memory 104, frames in the cache 106, and/or frames in storage 108; frames received from a remote source, such as a remote camera, a server or a content provider; frames obtained from a combination of sources; etc. For example, the ISP 118 can perform sHDR to generate an HDR image based on frames with different exposures captured by the image sensor 102. The ISP 118 can merge the frames with different exposures to generate an HDR image that retains and/or captures a wider array of color, brightness, and/or shadow details. In some examples, the ISP 118 can implement (e.g., via image processing engine 120) one or more algorithms and/or schemes for sHDR. For example, the ISP 118 can implement one or more sHDR schemes as illustrated in FIGS. 3 through 5 and further described below with respect to FIGS. 3 through 5.

The writer 122 can be a software and/or hardware component that can write (e.g., save/store) data to the memory 104, the cache 106, and/or storage 108. In some examples, the writer 122 can write data to the cache 106, such as exposures or frames from the image sensor 102. Moreover, in some cases, the writer 122 can include multiple writers and/or processes for writing different data items, such as different exposures or frames, to the memory 104, the cache 106, and/or storage 108. In some examples, the writer 122 can be implemented by one or more of the compute components 110. For example, in some cases, the writer 122 can be implemented and/or can be part of the ISP 118.

The reader 124 can be a software and/or hardware component that can read (e.g., access/retrieve) data stored on the memory 104, the cache 106, and/or storage 108. In some examples, the reader 124 can read data stored in the cache 106, such as exposures or frames. Moreover, in some cases, the reader 124 can include multiple readers and/or processes for reading different data items, such as different exposures or frames, from the memory 104, the cache 106, and/or storage 108. In some examples, the reader 124 can be implemented by one or more of the compute components 110. For example, in some cases, the reader 124 can be implemented and/or can be part of the ISP 118.

While the image processing system 100 is shown to include certain components, one of ordinary skill will appreciate that the image processing system 100 can include more or fewer components than those shown in FIG. 1. For example, the image processing system 100 can also include, in some instances, one or more memory devices (e.g., RAM, ROM, cache, and/or the like), one or more networking interfaces (e.g., wired and/or wireless communications interfaces and the like), one or more display devices, and/or other hardware or processing devices that are not shown in FIG. 1. An illustrative example of a computing device and hardware components that can be implemented with the image processing system 100 is described below with respect to FIG. 8.

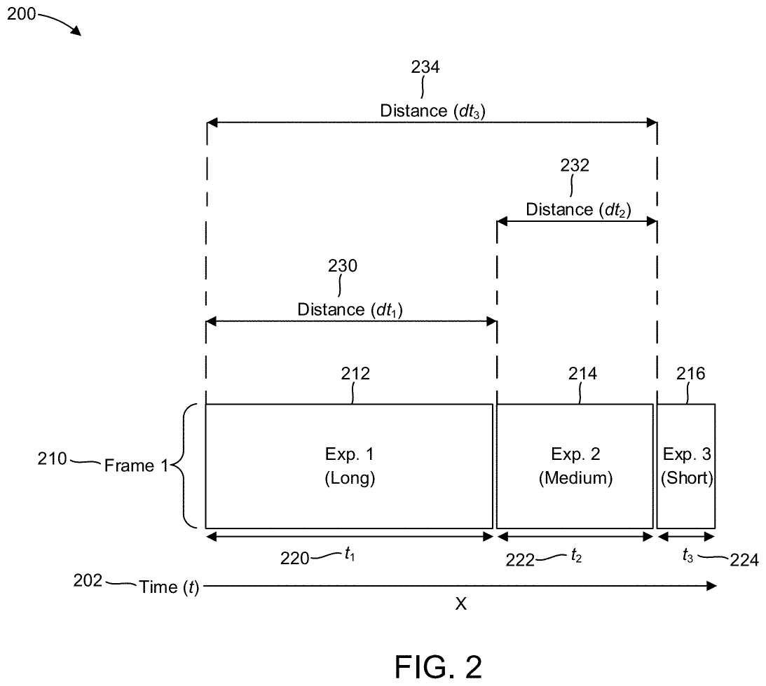

FIG. 2 is a simplified block diagram illustrating an example sHDR image capture sequence 200. The sHDR image capture sequence 200 can represent an example sequence for capturing different exposures 212-216 of a frame 210 in an sHDR application. The different exposures 212-216 can be staggered or captured within the same frame (210) and/or frame rate by varying the shutter speed or exposure time of the image sensor 102. Thus, the different exposures 212-216 can represent different sets of image data with different exposure times 220-224 captured along a time dimension. In some cases, the different exposures 212-216 can be captured within a time period 202 of the frame 210, and each of the different exposure times 220-224 can represent a time within the time period 202 of the frame 210. Moreover, in some examples, the different exposures 212-216 can be captured within a frame rate associated with the frame 210. For example, the image sensor 102 can capture the exposures 212-216 within the frame rate of the frame 210, with each of the exposures 212-216 having a different exposure time (e.g., 220, 222, or 224).

The different exposures 212-216 can include a longer exposure 212, a medium exposure 214, and a shorter exposure 216. As previously explained, exposure relates to the amount of light that reaches the image sensor capturing the frame 210, as determined by shutter speed or exposure time, lens aperture, and scene luminance. Thus, the different exposures 212-216 can correspond to different exposure times used to capture image data for the frame 210, which result in different amounts of light reaching the image sensor 102 when capturing the different exposures 212-216 for the frame 210. In this example, the longer exposure 212 can represent image data (e.g., lines of pixels, color channels, pixels, etc.) captured (e.g., via the image sensor 102) with a longer exposure time than the medium exposure 214 and the shorter exposure 216, the medium exposure 214 can represent image data captured (e.g., via the image sensor 102) with a shorter exposure time than the longer exposure 212 but a longer exposure time than the shorter exposure 216, and the shorter exposure can represent image data captured (e.g., via the image sensor 102) with a shorter exposure than both the longer exposure 212 and the medium exposure 214.

Since the longer exposure 212 corresponds to a longer exposure time than the medium exposure 214 and the shorter exposure 216, the longer exposure 212 can capture more light associated with the captured scene, and can include more highlight or brightness details. Since the medium exposure 214 corresponds to a shorter exposure time than the longer exposure 212 but a longer exposure time than the shorter exposure 216, it can capture less light than the longer exposure 212 but more light than the shorter exposure 216, and can include more shadow details than the longer exposure 212 and more highlight or brightness details than the shorter exposure 216. On the other hand, since the shorter exposure 216 corresponds to a shorter exposure time than the longer exposure 212 and the medium exposure 214, it can capture less light than the longer exposure 212 and the medium exposure 214 but more shadow details than the longer exposure 212 and the medium exposure 214. Thus, the combination of the longer exposure 212, the medium exposure 214, and the shorter exposure 216 can include a greater range of color and luminance levels or details (e.g., more highlight/brightness details and more shadow details) than any of the exposures 212-216 individually.

As shown in FIG. 2, the distances 230-234 (e.g., the amount of time) between the start of one exposure and the start of another exposure can vary based on the exposure times 220-224 of the different exposures 212-216. For example, the distance 230 between the start of the longer exposure 212 and the start of the medium exposure 214 at least partly depends on the exposure time 220 of the longer exposure 212, the distance 232 between the start of the medium exposure 214 and the start of the shorter exposure 216 at least partly depends on the exposure time 222 of the medium exposure 214, and the distance 234 between the start of the longer exposure 212 and the start of the shorter exposure 216 at least partly depends on the exposure time 220 of the longer exposure 212 and the exposure time 222 of the medium exposure 214.

Thus, since the exposure time 220 of the longer exposure 212 is longer than the exposure time 222 of the medium exposure 214, the distance 230 between the start of the longer exposure 212 and the start of the medium exposure 214 is greater/longer than the distance 232 between the start of the medium exposure 214 and the start of the shorter exposure 216. Moreover, since the distance 234 between the start of the longer exposure 212 and the start of the shorter exposure 216 at least partly depends on both the exposure time 220 of the longer exposure 212 and the exposure time 222 of the medium exposure 214, it is longer than the distance 230 between the start of the longer exposure 212 and the start of the medium exposure 214 and the distance 232 between the start of the medium exposure 214 and the start of the shorter exposure 216. Accordingly, the latency or delay between the start of the longer exposure 212 and the start of the shorter exposure 216 is greater/longer than the latency or delay between the start of the longer exposure 212 and the start of the medium exposure 214 and the latency or delay between the start of the medium exposure and the start of the shorter exposure 216.

The exposure times 220-224 of the different exposures 212-216 can affect the amount of data included in the different exposures 212-216, the distances 230-234 between the start of the different exposures 212-216 and the amount of latency/delay between the start of the different exposures 212-216. Thus, as further described below, the exposure times 220-224 (and the distances 230-234) can affect how many of the different exposures 212-216 can be buffered or cached (e.g., in the cache 106) and/or how many of the different exposures 212-216 can be merged in real time. For example, the exposure times 220-224 (and the distances 230-234) can affect whether the cache 106 on the image processing system 100 has enough space to store all or only a certain subset of the exposures 212-216.

As illustrated in FIG. 2, the different exposures 212-216 can be captured sequentially and/or according to a specific ordering. Moreover, while the exposures 212-216 are shown in FIG. 2 without an overlap between their respective capture periods, in some cases, at least some of the exposures 212-216 can have some overlap in their respective capture periods. For example, in some cases, exposure 214 can start some time before exposure 212 ends, and/or exposure 216 can start some time before exposure 214 ends.

FIG. 3 is a simplified block diagram illustrating an example implementation 300 of an sHDR process. As shown in FIG. 3, the implementation 300 can use a cache 106 to store or save one or more of the exposures 212-216 captured by the image sensor 102 and subsequently merged by the image processing engine 120, in order to avoid storing or saving one or more of the exposures 212-216 in the memory 104.

In some examples, the cache 106 can be a buffer or cache implemented by, and/or part of, the ISP 118 and the memory 104 can represent a hardware memory on the image processing system 100, such as DDR memory, which can have higher power and bandwidth requirements or utilization than the cache 106. Thus, by storing or saving one or more of the exposures 212-216 in the cache 106 rather than the memory 104, the image processing system 100 can reduce the amount of additional power and bandwidth used for the sHDR process. In other words, by storing or saving one or more of the exposures 212-216 in the cache 106 rather than the memory 104, the image processing system 100 can offload some of the power and bandwidth requirements of the memory 104 to the cache 106.

In the example implementation 300, the image sensor 102 can first capture exposure 212 and provide the exposure 212 to the writer 122. The writer 122 can then write (e.g., save or store) the exposure 212 to the memory 104. The image sensor 102 can then capture exposure 214 and provide the exposure 214 to the writer 122, which can similarly write the exposure 214 to the memory 104. The image sensor 102 can then capture a last exposure, exposure 216, and provide the exposure 216 to the writer 122. Instead of writing the last exposure 216 to the memory 104 as before, the writer 122 can write the last exposure 216 to the cache 106, in order to save the additional amount of power and bandwidth otherwise used to write the last exposure 216 to the memory 104 and read the last exposure 216 from the memory 104.

The reader 124 can read or retrieve the exposures 212 and 214 from the memory 104 and the last exposure 216 from the cache 106, and provide the exposures 212-216 to the image processing engine 120 so the image processing engine 120 can perform an sHDR merge of the exposures 212-216 and generate an HDR image or frame. The image processing engine 120 can thus receive the exposures 212-216 from the reader 124, merge image data (e.g., pixels) from the exposures 212-216 and generate a merged output 302. The merged output 302 can be a single frame produced from the exposures 212-216, and can include brightness/highlight details from one or more of the exposures 212-216 and/or shadow details from one or more of the exposures 212-216. Thus, the merged output 302 can include an HDR image that has a greater range of color and/or luminance details (e.g., brightness/highlight and/or shadow details) than each of the exposures 212-216 individually.

In some cases, instead of writing only one exposure (e.g., 216) to the cache 106, the writer 122 can write multiple exposures to the cache 106. For example, if the cache 106 is large enough to store the last exposure 216 and the previous exposure, exposure 214, the writer 122 can write both of the exposures 214 and 216 to the cache 106. In this example, the reader 124 can read or retrieve the exposure 212 from the memory 104 and the exposures 214 and 216 from the cache 106, and subsequently provide the exposures 212-216 to the image processing engine 120 for the sHDR merge. This can allow the image processing system 100 to offload additional power and bandwidth requirements for the exposure 214 from the memory 104 to the cache 106, and thereby provide additional power and bandwidth savings. In other examples, if the cache 106 is large enough to store all of the exposures 212-216, the writer 122 can write all of the exposures 212-216 to the cache 106 and avoid saving any of the exposures 212-216 to the memory 104 altogether. This can provide additional power and bandwidth savings, as previously explained.

In some cases, the number of exposures saved or stored in the cache 106 can depend on the size of the cache 106, the amount of available space in the cache 106, and the size of the different exposures 212-216. Moreover, as previously explained, the size of the different exposures 212-216 can at least partly depend on the exposure times (e.g., 220-224) of the different exposures 212-216 and/or the distances (e.g., 230-234) between the start of the different exposures 212-216.

It should be noted that the number of exposures and/or the exposure time associated with each exposure can vary in different examples. Thus, while FIG. 3 illustrates three exposures (e.g., 212-216) used for the sHDR process, other examples may use more or fewer exposures, and each exposure can have a same or different exposure time than exposures 212, 214, or 216 in FIG. 3. For example, in some cases, instead of using a long exposure (e.g., 212), a medium exposure (e.g., 214) and a shorter exposure (e.g., 216), the sHDR process can use two exposures which can include, for example, a long exposure and a medium or short exposure, a medium exposure and a long or short exposure, or a short exposure and a long or medium exposure.

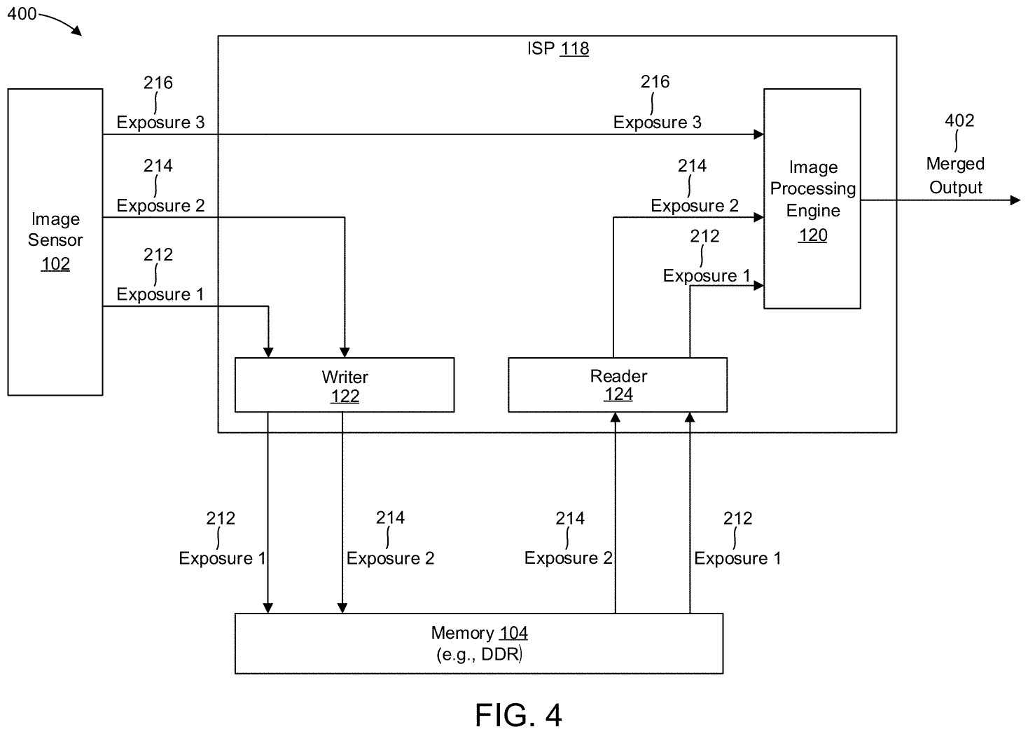

FIG. 4 is a simplified block diagram illustrating another example implementation 400 of an sHDR process. In this example, instead of saving or storing the last exposure 216 to the cache 106 and subsequently providing the last exposure 216 to the image processing engine 120, the image processing engine 120 can obtain the last exposure 216 from the image sensor 102 and merge the last exposure 216 with exposures 212 and 214 in real time (or near real time) and/or when it finishes receiving the exposures 212 and 214. Thus, the image processing system 100 can avoid the power and bandwidth costs or requirements associated with writing and reading the last exposure 216 to and from the cache 106 (and the memory 104), and thereby provide power and bandwidth savings.

To illustrate, as shown in FIG. 4, the image sensor 102 can first capture exposure 212 and provide the exposure 212 to the writer 122. The writer 122 can then write (e.g., save or store) the exposure 212 to the memory 104. The image sensor 102 can then capture exposure 214 and provide the exposure 214 to the writer 122, which can similarly write the exposure 214 to the memory 104. The image sensor 102 can subsequently capture a last exposure, exposure 216, and provide the exposure 216 to the image processing engine 120, instead of writing the last exposure 216 to the memory 104 or the cache 106 as in FIG. 3, in order to save the additional amount of power and bandwidth otherwise used to write the last exposure 216 to the memory 104 (or cache 106) and read the last exposure 216 from the memory 104 (or cache 106).

The reader 124 can read or retrieve the exposures 212 and 214 from the memory 104, and provide the exposures 212-216 to the image processing engine 120 so the image processing engine 120 can perform an sHDR merge of the exposures 212-216 and generate an HDR image or frame. The image processing engine 120 can thus receive the exposures 212-214 from the reader 124 and the exposure 216 from the image sensor 102, merge pixels from the exposures 212-216 and generate a merged output 402. The merged output 402 can be a single frame produced from the exposures 212-216, and can include brightness/highlight details from one or more of the exposures 212-216 and/or shadow details from one or more of the exposures 212-216. Thus, the merged output 402 can include an HDR image/frame that has a greater range of color and/or luminance details (e.g., brightness/highlight and/or shadow details) than each of the exposures 212-216 individually.

In some cases, there can be a certain amount of delay or latency in writing the exposures 212 and 214 to the memory 104 and reading the exposures 212 and 214 from the memory 104. However, the time for the image sensor 102 to provide the exposure 216 to the image processing engine 120 and/or the time for the image processing engine 120 to process the exposure 216 from the image sensor 102 may not be delayed or stalled or may be delayed or stalled for only a limited amount. Thus, the delay or latency in writing and/or reading the exposures 212 and 214 in the memory 104 can cause a delay between the time that the image processing engine 120 receives the exposure 216 from the sensor 102 and the time it receives the exposures 212 and 214 from the memory 104.

Thus, in some cases, to ensure that (or increase the likelihood that) the exposures 212 and 214 retrieved from the memory 104 arrive at the image processing engine 120 at the same time (or near the same time) as the exposure 216 from the image sensor 102, the processing system 100 can implement priorities for writing and/or reading the exposures 212 and 214 to and/or from the memory 104. For example, the operations for reading the exposures 212 and 214 from the memory 104 (and/or the exposures 212 and 214) can be assigned higher priorities (or a high or highest priority) than other operations or data. This way, the exposures 212 and 214 can be fetched by the memory subsystem and/or the reader 124 with a high (or higher) priority in order to reduce the latency in retrieving the exposures 212 and 214 from the memory 104 and increase the likelihood that the exposures 212 and 214 arrive at the image processing engine 120 at the same time (or near the same time) as the exposure 216 from the image sensor 102. Accordingly, the image processing engine 120 can merge the exposure 216 with the exposures 212 and 214 in real time as it receives the exposure 216 from the image sensor 102 and/or in near real time or shortly after receiving the exposure 216 from the image sensor 102.

In some cases, instead of, or in addition to, using priorities to reduce the latency in which the exposures 212 and/or 214 are written to, and/or retrieved from, the memory 104, the image processing system 100 can store the exposures 212 and/or 214 on the cache 106 and retrieve the exposures 212 and/or 214 from the cache 106, as previously described with reference to FIG. 3. Since the cache 106 can provide faster read and/or write times or performance than the memory 104, this approach can help reduce the latency experienced when providing the exposures 212 and/or 214 to the image processing engine 120 from the memory 104. In addition, since the cache 106 can have lower power requirements than the memory 104, this approach can also provide power savings by offloading the power usage from the memory 104 to the cache 106.

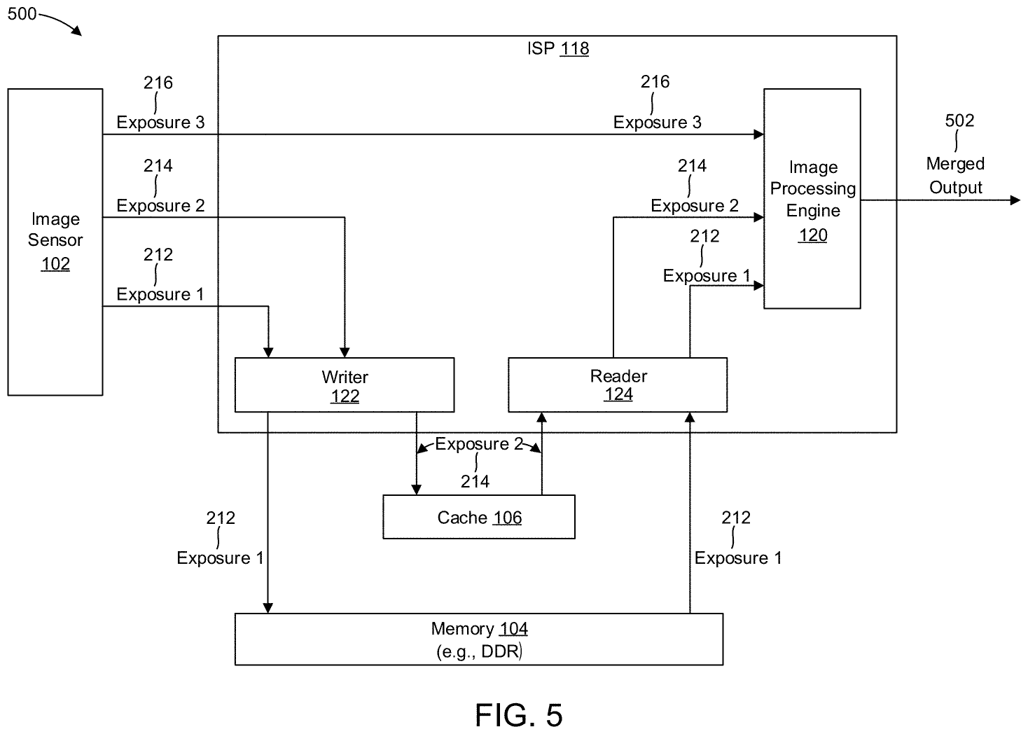

For example, with reference to FIG. 5, which illustrates another example implementation 500 of an sHDR process, the image sensor 102 can provide the exposures 212 and 214 to the writer 122 for storing the exposures 212 and 214 respectively in the memory 104 and the cache 106, while instead providing the last exposure 216 to the image processing engine 120 for processing. In this example, the image sensor 102 can first capture exposure 212 and provide the exposure 212 to the writer 122. The writer 122 can write (e.g., save or store) the exposure 212 to the memory 104. The image sensor 102 can also capture exposure 214 and provide the exposure 214 to the writer 122, which can write the exposure 214 to the cache 106 to reduce the amount of latency in providing the exposure 214 to the image processing engine 120. The image sensor 102 can subsequently capture a last exposure, exposure 216, and provide the exposure 216 to the image processing engine 120, instead of writing the last exposure 216 to the memory 104 or the cache 106, in order to save the additional amount of power and bandwidth otherwise used to write the last exposure 216 to the memory 104 or cache 106 and read the last exposure 216 from the memory 104 or cache 106.

The reader 124 can read or retrieve the exposure 212 from the memory 104 and the exposure 214 from the cache 106, and provide the exposures 212-216 to the image processing engine 120 so the image processing engine 120 can perform an sHDR merge of the exposures 212-216 and generate an HDR image or frame. The cache 106 can have faster read and/or write times than the memory 104, which can reduce the amount of time the exposure 214 takes to arrive at the image processing engine 120 and thus increase the likelihood that the exposure 214 and the exposure 216 will arrive at the same (or near the same) time. By reducing the amount of data that is written to and read from the memory 104, the image processing system 100 can increase the likelihood that the exposure 212 stored in the memory 104 will similarly arrive at the image processing engine 120 at the same (or near the same) time as the exposure 216 (and the exposure 214). In some examples, higher priorities can also be used as previously described to write and/or read the exposure 212 to and from the memory 104, and consequently reduce the latency in providing the exposure 212 to the image processing engine 120 and increase the likelihood that the exposure 212 stored in the memory 104 will arrive at the image processing engine 120 at the same time (or near the same time) as the exposure 216 (and the exposure 214).

The image processing engine 120 can receive the exposures 212-214 from the reader 124 and the exposure 216 from the image sensor 102, merge image data (e.g., pixels) from the exposures 212-216 and generate a merged output 502. The merged output 502 can be a single frame produced from the exposures 212-216, and can include brightness/highlight details from one or more of the exposures 212-216 and/or shadow details from one or more of the exposures 212-216. Thus, the merged output 502 can include an HDR image or frame that has a greater range of color and/or luminance details (e.g., brightness/highlight and/or shadow details) than each of the exposures 212-216 individually.

In some cases, instead of writing the exposure 212 to the memory 104, the writer 122 can write the exposure 212 to the cache 106. Thus, the writer 122 can write both of the exposures 212 and 214 to the cache 106 and avoid writing or reading any of the exposures 212-216 to and from the memory 104. The reader 124 can thus retrieve both of the exposures 212 and 214 from the cache 106 and provide them to the image processing engine 120 for merging with the exposure 216 from the image sensor 102. By storing and retrieving both of the exposures 212 and 214 from the cache 106 rather than the memory 104, the image processing system 100 can further increase the likelihood that both of the exposures 212 and 214 will arrive at the image processing engine 120 at the same time (or near the same time) as the exposure 216 from the image sensor 102.

In addition, by storing and retrieving both of the exposures 212 and 214 from the cache 106 rather than the memory 104, the image processing system 100 can further reduce the power and bandwidth requirements for the sHDR process. For example, as previously explained, the cache 106 can have lower power and bandwidth requirements than the memory 104. Thus, by using the cache 106 to store or buffer the exposures 212 and 214 and bypassing the memory 104, the image processing system 100 can eliminate or reduce the additional power and bandwidth used by the memory 104 (e.g., relative to the cache 106) for read and write operations associated with the exposures 212 and 214, and thereby reduce the overall power and bandwidth utilized by the image processing system 100 to perform sHDR for the different exposures 212-216.

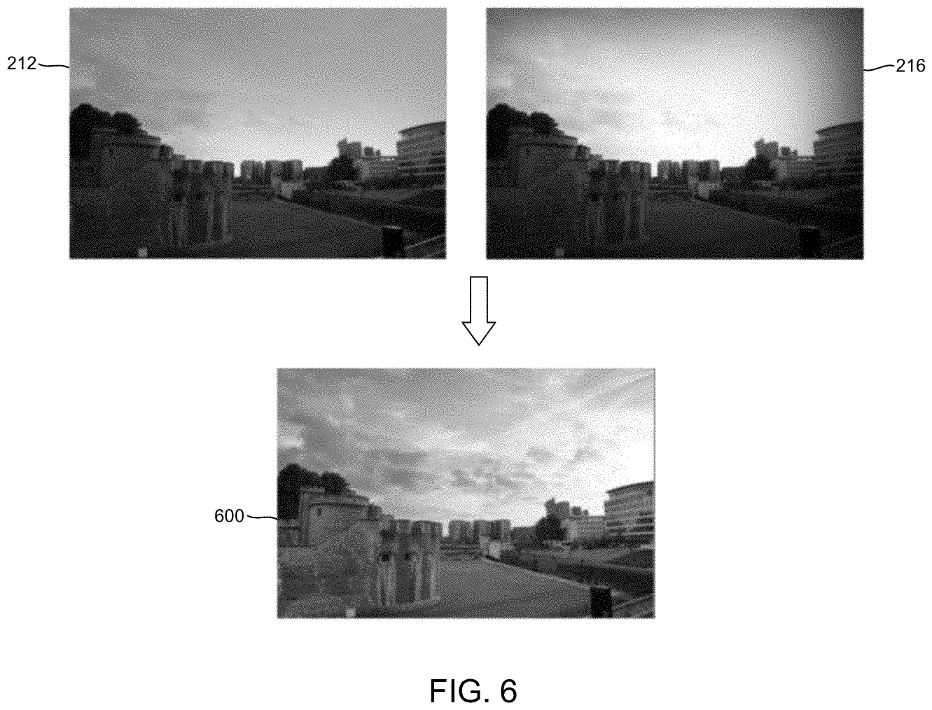

FIG. 6 illustrates an example HDR image 600 generated according to an example sHDR process by merging a longer exposure 212 captured by the image sensor 102 and a shorter exposure 216 captured by the image sensor 102. In this example, the longer exposure 212 and the shorter exposure 216 both depict a same scene. However, the longer exposure 212 includes higher brightness/highlight levels caused by the greater amount of light captured as a result of the longer exposure time used when capturing the longer exposure 212, and the shorter exposure 216 includes higher shadow/dark levels caused by the lower amount of light captured as a result of the shorter exposure time used when capturing the shorter exposure 216.

During an sHDR process as described in implementation 300, 400 or 500 shown in FIGS. 3-5, the image processing engine 120 can merge image data (e.g., pixels) from the longer exposure 212 with image data (e.g., pixels) from the shorter exposure 216 to produce the HDR image 600. When merging image data from the longer exposure and the shorter exposure 216, the image processing engine 120 can incorporate some of the highlight/brightness details from the longer exposure 212 and some of the shadow details from the shorter exposure 216, to produce a higher quality image with a better range or balance of brightness/highlight and shadow details.

By merging image data from the longer exposure 212 and the shorter exposure 216, the image processing engine 120 can produce a merged output (e.g., 302, 402, or 502) represented by the HDR image 600. The HDR image 600 can include highlight/brightness and shadow details from the longer exposure 212 and the shorter exposure 216, to capture a wider range of color and luminance levels than either the longer exposure 212 or the shorter exposure 216.

Having disclosed example systems, components and concepts, the disclosure now turns to the example method 700 for implementing an sHDR process and reducing the resource (e.g., bandwidth) and power usage and requirements of the sHDR process, as shown in FIG. 7. The steps outlined herein are non-limiting examples provided for illustration purposes, and can be implemented in any combination thereof, including combinations that exclude, add, or modify certain steps.

At block 702, the method 700 can include storing (e.g., via a write operation), on a first memory (e.g., memory 104 or cache 106), a first exposure (e.g., exposure 212, 214, or 216) including a first set of image data (e.g., pixels, lines of pixels, color channels, etc.) associated with an image frame (e.g., frame 210) and being captured by an image sensor (e.g., image sensor 102) during a first time period associated with the image frame. The image frame (e.g., frame 210) can also be referred to as a frame. The first time period can be within a time period (e.g., 202) of the image frame. For example, the first time period can be within a frame rate of the image frame. Moreover, the first image can have a first exposure time (e.g., 220, 222, or 224), such as a longer exposure time (e.g., 220), a medium exposure time (e.g., 222), or a shorter exposure time (e.g., 224).

In some cases, the first memory can include, for example, a volatile memory. Moreover, the volatile memory can include, for example, a random access memory (RAM), a dynamic RAM (DRAM), a static RAM (SRAM), a synchronous DRAM (SDRAM), or a double data rate (DDR) SDRAM. In some examples, the first exposure is retrieved from the volatile memory based on a higher priority parameter associated with a lower latency. For example, the first exposure can be retrieved using a read operation having a high priority that increases a priority of the read operation and reduces a delay or latency of the read operation.

At block 704, the method 700 can include obtaining (e.g., retrieving via a read operation, receiving, etc.) the first exposure from the first memory.

At block 706, the method 700 can include obtaining (e.g., retrieving, receiving, etc.), from one of a second memory (e.g., memory 104 or cache 106) or the image sensor, a second exposure (e.g., exposure 212, 214, or 216) including a second set of image data associated with the image frame and being captured by the image sensor during a second time period associated with the image frame. The second time period can be within a time period (e.g., 202) of the image frame. For example, the second time period can be within a frame rate of the image frame. In some examples, the second time period can be different than the first time period such that the first exposure and the second exposure (or the capture thereof) are staggered in time within the time period (e.g., 202) or frame rate of the image frame.

Moreover, in some cases, the second exposure can have a second exposure time that is different than the first exposure time. For example, in some cases, one of the first exposure time or the second exposure time can include a longer exposure time (e.g., 220) and a different one of the first exposure time or the second exposure time can include a shorter exposure time (e.g., 222 or 224) that is shorter than the longer exposure time. To illustrate, the first exposure time can be the longer exposure time and the second exposure time can be the shorter exposure time (in which case the first exposure time is greater than the second exposure time), or the second exposure time can be the longer exposure time and the first exposure time can be the shorter exposure time (in which case the first exposure time is less than the second exposure time).

In some cases, obtaining the second exposure from one of the second memory or the image sensor can include obtaining the second image from the second memory. In other cases, obtaining the second exposure from one of the second memory or the image sensor can include obtaining the second exposure from the image sensor without first storing the second exposure on the first memory or the second memory.

In some examples, the second memory can be a cache (e.g., cache 106). In other examples, the second memory can be a volatile memory such as, for example, a RAM, a DRAM, an SRAM, an SDRAM, or a DDR SDRAM.

At block 708, the method 700 can include merging the first set of image data and the second set of image data from the first exposure and the second exposure. For example, in some cases, an image processing engine (e.g., image processing engine 120) can combine the first exposure and the second exposure (or at least a portion of the first exposure and a portion of the second exposure) to yield a combined output (e.g., merged output 302, 402, 502, or 600) that includes highlight/brightness and shadow details from both of the first exposure and the second exposure. In some examples, the first set of image data and the second set of image data from the first exposure and the second exposure can be merged using a high dynamic range (HDR) algorithm.

At block 710, the method 700 can include generating an HDR image (e.g., merged output 302, 402, 502, or 600) based on the first set of image data and the second set of image data merged from the first exposure and the second exposure. In some examples, the HDR image can incorporate color, luminance, and/or other details from the first and second exposures.

In some aspects, the method 700 can include obtaining (e.g., retrieving, receiving, etc.) a third exposure (e.g., exposure 212, 214, or 216) including a third set of image data associated with the image frame. For instance, the third exposure can be obtained from the image sensor (e.g., image sensor 102) that captured the first exposure. The method 700 can include merging the first set of image data, the second set of image data and the third set of image data from the first exposure, the second exposure, and the third exposure, and generating the HDR image based on the sets of image data merged from the first exposure, the second exposure, and the third exposure. In some examples, the third exposure can be obtained from the image sensor without first storing the third exposure on the first memory or the second memory. For example, the third exposure can be obtained by a processor (e.g., ISP 118) and/or a processing engine (e.g., image processing engine 120) used to merge the sets of image data and generate the HDR image. The third exposure can be obtained directly from the image sensor or via an inline communication path/flow between the image sensor and the processor and/or processing engine.

In some examples, the sets of image data from the first exposure, the second exposure, and the third exposure are merged via one or more processors (e.g., ISP 118) and/or a processing engine (e.g., image processing engine 120) implemented by the one or more processors, and the HDR image is generated via the one or more processors and/or the processing engine. In some cases, the first exposure is obtained by the one or more processors and/or the processing engine from the first memory, the second exposure is obtained by the one or more processors and/or the processing engine from the second memory, and the third exposure is obtained by the one or more processors and/or the processing engine from the image sensor.

In some cases, the first exposure (and/or the first set of image data) can include a first portion of the image frame, the second exposure (and/or the second set of image data) can include a second portion of the image frame, and the third exposure (and/or the third set of image data) can include a third portion of the image frame. Moreover, in some cases, the first exposure, the second exposure, and the third exposure can be captured within a frame rate of the image frame (e.g., 202), and the third exposure can have a third exposure time (e.g., 220, 222, or 224) and can be captured by the image sensor during a third time period associated with the image frame (e.g., 202).

In some examples, one of the first exposure time, the second exposure time, or the third exposure time can include a longer exposure time (e.g., 220), a different one of the first exposure time, the second exposure time, or the third exposure time can include a shorter exposure time (e.g., 224), and another different one of the first exposure time, the second exposure time, or the third exposure time can include a medium exposure time (e.g., 222) that is shorter than the longer exposure time and longer than the shorter exposure time. For example, the first exposure time can be the longer exposure time, the second exposure time can be the medium exposure time, and the third exposure time can be the shorter exposure time.

In some aspects, the method 700 can include initiating the merging of image data from the first exposure and the second exposure as the first exposure is obtained from the first memory and the second exposure is obtained from the image sensor, and merging image data from the first exposure and the second exposure after the first exposure is obtained from the first memory and the second exposure is received from the image sensor. For example, the method 700 can include initiating the merging of image data from the first exposure and the second exposure in real time (or near real time) when the first exposure is obtained from the first memory and the second exposure is obtained from the image sensor, or as the first exposure is obtained from the first memory and the second exposure is obtained from the second memory. The method 700 can then include merging image data from the first exposure and the second exposure after (or when) the first exposure is obtained from the first memory and the second exposure is obtained from the image sensor and/or in real time (or near real time) as the second exposure is received from the image sensor and the first exposure is received from the first memory.

In some aspects, the method 700 can include obtaining, by an image processing system (e.g., image processing system 100), the first set of image data and the second set of image data from the image sensor. The image frame can include, for example, the first exposure and the second exposure. In some cases, the first exposure and the second exposure can be captured by the image sensor within a frame rate or time period (e.g., 202) of the image frame. Moreover, in some examples, the first exposure (and/or the first set of image data) can include a first portion of the image frame and the second exposure (and/or the second set of image data) can include a second portion of the image frame. In some cases, the first portion of the image frame and the second portion of the image frame can be non-overlapping portions. In other cases, the first portion of the image frame and the second portion of the image frame can have at least some overlap. In other words, at least part of the first portion and the second portion can include or correspond to a same portion or time period of the image frame.

In some cases, the first exposure and the second exposure can be received by an image processing system (e.g., 100) associated with the first memory and the second memory, and the first exposure can be received by the image processing system before the second exposure. Moreover, in some examples, the first exposure time associated with the first exposure and the second exposure time associated with the second exposure are within a frame time or time period associated with the frame. For example, assume a different frame is produced every 33 milliseconds (ms) and thus, the frame time or time period associated with a frame is 33 ms. In addition, assume that the image sensor captures a first exposure for the frame and a second exposure for the frame, which are merged to generate the frame as described above, In this example, the first exposure and the second exposure are captured within the 33 ms frame time of the frame. Thus, while the frame is composed of multiple exposures, the multiple exposures when merged to generate the frame do not exceed the 33 ms frame time associated with the frame.

In some cases, the first exposure and the second exposure can be received by an image processing system associated with the first memory and the second memory, and the first exposure can be received by the image processing system after the second exposure. Moreover, in some examples, the first exposure time associated with the first exposure and the second exposure time associated with the second exposure are within a frame rate or time period associated with the frame.

In some examples, the method 700 may be performed by one or more computing devices or apparatuses. In one illustrative example, the method 700 can be performed by the image processing system 100 shown in FIG. 1 and/or one or more computing devices with the computing device architecture 800 shown in FIG. 8. In some cases, such a computing device or apparatus may include a processor, microprocessor, microcomputer, or other component of a device that is configured to carry out the steps of the method 700. In some examples, such computing device or apparatus may include one or more sensors configured to capture image data. For example, the computing device can include a smartphone, a head-mounted display, a mobile device, or other suitable device. In some examples, such computing device or apparatus may include a camera configured to capture one or more images or videos. In some cases, such computing device may include a display for displaying images. In some examples, the one or more sensors and/or camera are separate from the computing device, in which case the computing device receives the sensed data. Such computing device may further include a network interface configured to communicate data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The method 700 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the method 700 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 illustrates an example computing device architecture 800 of an example computing device which can implement various techniques described herein. For example, the computing device architecture 800 can implement at least some portions of the image processing system 100 shown in FIG. 1, and perform sHDR operations as described herein. The components of the computing device architecture 800 are shown in electrical communication with each other using a connection 805, such as a bus. The example computing device architecture 800 includes a processing unit (CPU or processor) 810 and a computing device connection 805 that couples various computing device components including the computing device memory 815, such as read only memory (ROM) 820 and random access memory (RAM) 825, to the processor 810.

The computing device architecture 800 can include a cache of high-speed memory connected directly with, in close proximity to, or integrated as part of the processor 810. The computing device architecture 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other computing device memory 815 may be available for use as well. The memory 815 can include multiple different types of memory with different performance characteristics. The processor 810 can include any general purpose processor and a hardware or software service stored in storage device 830 and configured to control the processor 810 as well as a special-purpose processor where software instructions are incorporated into the processor design. The processor 810 may be a self-contained system, containing multiple cores or processors, a bus, memory controller, cache, etc. A multi-core processor may be symmetric or asymmetric.

To enable user interaction with the computing device architecture 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art, such as a display, projector, television, speaker device. In some instances, multimodal computing devices can enable a user to provide multiple types of input to communicate with the computing device architecture 800. The communication interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. The storage device 830 can include software, code, firmware, etc., for controlling the processor 810. Other hardware or software modules are contemplated. The storage device 830 can be connected to the computing device connection 805. In one aspect, a hardware module that performs a particular function can include the software component stored in a computer-readable medium in connection with the necessary hardware components, such as the processor 810, connection 805, output device 835, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

1. A method comprising:
storing, in a first memory, a first exposure comprising a first set of image data associated with a frame, the first exposure having a first exposure time and being captured by an image sensor during a first time period associated with the frame;
obtaining the first exposure from the first memory;
obtaining, from one of a second memory or the image sensor, a second exposure comprising a second set of image data associated with the frame, the second exposure having a second exposure time that is different than the first exposure time, the second exposure being captured by the image sensor during a second time period associated with the frame;
initiating a merging of the first set of image data from the first exposure and the second set of image data from the second exposure in response to obtaining at least a portion of the first exposure from the first memory and at least a portion of the second exposure from the second memory or the image sensor;
completing the merging of the first set of image data from the first exposure and the second set of image data from the second exposure after the first exposure is obtained from the first memory and the second exposure is obtained from the second memory or the image sensor; and
generating a high dynamic range (HDR) image based on the first set of image data and the second set of image data merged from the first exposure and the second exposure.

2. The method of claim 1, wherein the second memory comprises a cache.

3. The method of claim 1, wherein the first memory comprises a volatile memory, the volatile memory comprising one of a random access memory (RAM), a dynamic RAM (DRAM), a static RAM (SRAM), a synchronous DRAM (SDRAM), or a double data rate (DDR) SDRAM.

4. The method of claim 3, wherein the first exposure is obtained from the volatile memory based on a higher priority parameter associated with a lower latency.

5. The method of claim 3, further comprising:
obtaining a third exposure comprising a third set of image data associated with the frame, the second exposure being stored in the second memory and the third exposure being received from the image sensor without first storing the third exposure in the first memory or the second memory;
merging the first set of image data from the first exposure, the second set of image data from the second exposure, and the third set of image data from the third exposure; and
generating the HDR image based on the first set of image data, the second set of image data, and the third set of image data merged from the first exposure, the second exposure, and the third exposure.

6. The method of claim 5, wherein the first set of image data, the second set of image data, and the third set of image data from the first exposure, the second exposure, and the third exposure are merged using one or more processors and the HDR image is generated using the one or more processors, wherein the first exposure is obtained by the one or more processors from the first memory, the second exposure is obtained by the one or more processors from the second memory, and the third exposure is obtained by the one or more processors from the image sensor.

7. The method of claim 5, wherein the first set of image data of the first exposure comprises a first portion of the frame, the second set of image data of the second exposure comprises a second portion of the frame, and the third set of image data of the third exposure comprises a third portion of the frame, wherein the first exposure, the second exposure, and the third exposure are captured within a frame rate associated with the frame, the third exposure having a third exposure time and being captured by the image sensor during a third time period associated with the frame.

8. The method of claim 7, wherein the first exposure time is less than the second exposure time, and wherein the second exposure time is less than the third exposure time.

9. The method of claim 1, wherein obtaining the second exposure from one of the second memory or the image sensor comprises obtaining the second exposure from the image sensor without first storing the second exposure in the first memory or the second memory.

10. The method of claim 1, wherein:
initiating the merging of the first set of image data from the first exposure and the second set of image data from the second exposure comprises initiating the merging of the first set of image data from the first exposure and the second set of image data from the second exposure as at least the portion of the first exposure is obtained from the first memory and at least the portion of the second exposure is obtained from the image sensor and before at least a different portion of the first exposure is obtained from the first memory and at least a different portion of the second exposure is obtained from the image sensor; and
completing the merging of the first set of image data from the first exposure and the second set of image data comprises completing the merging of the first set of image data from the first exposure and the second set of image data from the second exposure after at least the portion of the first exposure and at least the different portion of the first exposure are obtained from the first memory and at least the portion of the second exposure and at least the different portion of the second exposure are obtained from the image sensor.

11. The method of claim 1, further comprising:
obtaining, by an image processing system, the first set of image data and the second set of image data from the image sensor, the frame comprising the first set of image data and the second set of image data, wherein the first exposure comprises a first portion of the frame and the second exposure comprises a second portion of the frame, and wherein the first exposure and the second exposure are captured within a frame time associated with the frame.

12. The method of claim 11, wherein the first exposure time is less than the second exposure time.

13. The method of claim 11, wherein the first exposure time is greater than the second exposure time.

14. The method of claim 1, wherein the first exposure and the second exposure are received by an image processing system associated with the first memory and the second memory, wherein the first exposure is received by the image processing system before the second exposure, and wherein the first exposure time associated with the first exposure and the second exposure time associated with the second exposure are within a frame rate associated with the frame.

15. The method of claim 1, wherein the first exposure and the second exposure are received by an image processing system associated with the first memory and the second memory, wherein the first exposure is received by the image processing system after the second exposure, and wherein the first exposure time associated with the first exposure and the second exposure time associated with the second exposure are within a frame rate associated with the frame.

16. An apparatus comprising:
at least one memory; and
one or more processors implemented in circuitry and configured to:
store, in a first memory, a first exposure comprising a first set of image data associated with a frame, the first exposure having a first exposure time and being captured by an image sensor during a first time period associated with the frame;
obtain the first exposure from the first memory;
obtain, from one of a second memory or the image sensor, a second exposure comprising a second set of image data associated with the frame, the second exposure having a second exposure time that is different than the first exposure time, the second exposure being captured by the image sensor during a second time period associated with the frame;
initiate a merge of the first set of image data from the first exposure and the second set of image data from the second exposure in response to obtaining at least a portion of the first exposure from the first memory and at least a portion of the second exposure from the second memory or the image sensor;
complete the merging of the first set of image data from the first exposure and the second set of image data from the second exposure after the first exposure is obtained from the first memory and the second exposure is obtained from the second memory or the image sensor; and
generate a high dynamic range (HDR) image based on the first set of image data and the second set of image data merged from the first exposure and the second exposure.

17. The apparatus of claim 16, wherein the second memory comprises a cache.

18. The apparatus of claim 16, wherein the first memory comprises a volatile memory, the volatile memory comprising one of a random access memory (RAM), a dynamic RAM (DRAM), a static RAM (SRAM), a synchronous DRAM (SDRAM), or a double data rate (DDR) SDRAM.

19. The apparatus of claim 18, wherein the at least one processor is configured to obtain the first exposure from the volatile memory based on a higher priority parameter associated with a lower latency.

20. The apparatus of claim 18, the one or more processors being configured to:
obtain a third exposure comprising a third set of image data associated with the frame, the second exposure being stored in the second memory and the third exposure being received from the image sensor without first storing the third exposure in the first memory or the second memory;
merge the first set of image data from the first exposure, the second set of image data from the second exposure, and the third set of image data from the third exposure; and
generate the HDR image based on the first set of image data, the second set of image data, and the third set of image data merged from the first exposure, the second exposure, and the third exposure.

21. The apparatus of claim 20, wherein the first set of image data, the second set of image data, and the third set of image data from the first exposure, the second exposure, and the third exposure are merged using the one or more processors and the HDR image is generated using the one or more processors, wherein the first exposure is obtained by the one or more processors from the first memory, the second exposure is obtained by the one or more processors from the second memory, and the third exposure is obtained by the one or more processors from the image sensor.

22. The apparatus of claim 20, wherein the first set of image data of the first exposure comprises a first portion of the frame, the second set of image data of the second exposure comprises a second portion of the frame, and the third set of image data of the third exposure comprises a third portion of the frame, wherein the first exposure, the second exposure, and the third exposure are captured within a frame rate associated with the frame, the third exposure having a third exposure time and being captured by the image sensor during a third time period associated with the frame.

23. The apparatus of claim 22, wherein the first exposure time is less than the second exposure time, and wherein the second exposure time is less than the third exposure time.

24. The apparatus of claim 16, wherein, to obtain second exposure from one of the second memory or the image sensor, the one or more processors are configured to obtain the second exposure from the image sensor without first storing the second exposure in the first memory or the second memory.

25. The apparatus of claim 16, wherein:
to initiate the merging of the first set of image data from the first exposure and the second set of image data from the second exposure, the one or more processors are configured to initiate the merging of the first set of image data from the first exposure and the second set of image data from the second exposure as at least the portion of the first exposure is obtained from the first memory and at least the portion of the second exposure is obtained from the image sensor and before at least a different portion of the first exposure is obtained from the first memory and at least a different portion of the second exposure is obtained from the image sensor; and
to complete the merging of the first set of image data from the first exposure and the second set of image data from the second exposure, the one or more processors are configured to complete the merge of the first set of image data from the first exposure and the second set of image data from the second exposure after at least the portion of the first exposure and at least the different portion of the first exposure are obtained from the first memory and at least the portion of the second exposure and at least the different portion of the second exposure are obtained from the image sensor.

26. The apparatus of claim 16, the one or more processors being configured to:
obtain the first set of image data and the second set of image data from the image sensor, the frame comprising the first set of image data and the second set of image data, wherein the first exposure comprises a first portion of the frame and the second exposure comprises a second portion of the frame, and wherein the first exposure and the second exposure are captured within a frame time associated with the frame.

27. The apparatus of claim 26, wherein the first exposure time is less or greater than the second exposure time.

28. The apparatus of claim 16, wherein the first exposure is received by the one or more processors before or after the second exposure, and wherein the first exposure time associated with the first exposure and the second exposure time associated with the second exposure are within a frame rate associated with the frame.

29. The apparatus of claim 16, wherein the apparatus is a mobile computing device.

30. A non-transitory computer-readable storage medium having stored thereon instructions that, when executed by one or more processors, cause the one or more processors to:
store, in a first memory, a first exposure comprising a first set of image data associated with a frame, the first exposure having a first exposure time and being captured by an image sensor during a first time period associated with the frame;
obtain the first exposure from the first memory;
obtain, from one of a second memory or the image sensor, a second exposure comprising a second set of image data associated with the frame, the second exposure having a second exposure time that is different than the first exposure time, the second exposure being captured by the image sensor during a second time period associated with the frame;
initiate a merge of the first set of image data from the first exposure and the second set of image data from the second exposure in response to obtaining at least a portion of the first exposure from the first memory and at least a portion of the second exposure from the second memory or the image sensor;
complete the merging of the first set of image data from the first exposure and the second set of image data from the second exposure after the first exposure is obtained from the first memory and the second exposure is obtained from the second memory or the image sensor; and
generate a high dynamic range (HDR) image based on the first set of image data and the second set of image data merged from the first exposure and the second exposure.
